(19) United States
(12) Patent Application Publication
(10) Pub. No.: US 2008/0231985 A1
(43) Pub. Date: Sep. 25, 2008

(54) Magnetic head having two main magnetic poles, magnetic disk apparatus and magnetic head switching control circuit

(75) Inventor: Makoto Okamoto, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/999,285

(22) Filed: Dec. 4, 2007

(30) Foreign Application Priority Data
Mar. 22, 2007 (JP) 2007-074272

(51) Int. Cl. G11B 21/02

(52) U.S. Cl. 360/75

(57) ABSTRACT

A magnetic head structure is disclosed which can avoid the problem of side erasing regardless of whether the skew angle is assigned to the positive side or negative side while ensuring write magnetic field intensity. The magnetic head includes at least two main magnetic poles having a single taper shape as a plane shape of a tip thereof opposite to a recording medium and axially symmetrically disposed with respect to a longitudinal direction of a slider, a return yoke for returning a write magnetic field generated by the main magnetic poles, and thin-film coils assigned to each of the main magnetic poles.

### BACKGROUND OF THE INVENTION

1. Field of the Invention

The present invention relates to a magnetic head for perpendicular magnetic recording that can control side erasing without causing write magnetic field intensity to decrease and a magnetic disk apparatus using thereof.

2. Description of the Related Art

As storage technology makes progress in recent years, magnetic disk apparatuses including HDDs (hard disk drives) have been used, in addition to the conventional use of external recording apparatuses of personal computers, servers, and the like, for various application uses such as video recorders, portable music players, car navigation systems, game machines, and mobile phones. Thus, still higher recording densities will be demanded. Under such circumstances, adoption of the perpendicular magnetic recording has begun as a technology to meet the needs for higher recording density.

Here, features of a recording medium and a magnetic head in the longitudinal magnetic recording and the perpendicular magnetic recording of conventionally used magnetic disk apparatuses will be described by comparing them.

First, recording media will be described by comparing them. In the longitudinal magnetic recording, recorded bits are magnetized in a direction in which they are opposite each other with respect to adjacent recorded bits. Thus, there is a concern about degradation of thermal stability accompanying a reduced recorded bit volume caused by higher recording densities. In the perpendicular magnetic recording, on the other hand, recorded bits are magnetized in a direction in which they are stabilized with adjacent recorded bits. Thus, this is a recording mode effective in ensuring thermal stability.

Also in the perpendicular magnetic recording, it becomes possible to abruptly draw a write magnetic field generated by a magnetic head to the recording medium side by forming a soft magnetic layer called a soft magnetic underlayer on the lower layer side of the recording layer. Thus, compared with a magnetic head of the longitudinal magnetic recording, effective write magnetic field intensity can be increased up to 1.5 to 2 times. Therefore, it becomes possible to have high coercivity imparted to the recording layer of recording medium, and low noise and thermal stability of the recording layer ensured.

Next, magnetic heads will be described by comparing them. The magnetic head is a generic name for two mechanisms: a write head element part to record a read signal by applying a write magnetic field to a recording medium and a read head element part to detect a read signal from a recording medium. The read head element part detects a read signal using a magneto-resistive effect by arranging a GMR (Giant Magneto Resistance) or TuMR (Tunneling Magneto Resistance) element between upper and lower magnetic shield layers playing a role of absorbing unnecessary signals (magnetic fields) excluding the read signal. Meanwhile, there is no major difference between a mechanism of the longitudinal magnetic recording and that of the perpendicular magnetic recording of the read head element part.

The write head element part, on the other hand, has a major difference between the mechanism of the longitudinal magnetic recording and that of the perpendicular magnetic recording. In the longitudinal magnetic recording, a ring write magnetic element having a gap is used to apply a write magnetic field in an in-plane (longitudinal) direction from the gap for recording. In the perpendicular magnetic recording, on the other hand, a single pole type write magnetic element comprising a main magnetic pole disposed perpendicular to a recording medium and a return yoke (return pole) used for forming a magnetic circuit by refluxing a write magnetic field applied in a vertical direction from the main magnetic pole via a soft magnetic underlayer of the recording medium is used for recording.

In order to improve performance of the write head element part of the perpendicular magnetic recording, proposals such as a trailing shield type write magnetic element, which has a modified return yoke form, and a cusp coil type write magnetic element, which has a modified coil form, have been made and such proposals will be described below.

The trailing shield type write magnetic element shown in FUJITSU, vol. 56, no. 4, pp. 286-291, 2005, for example, is characterized in that a soft magnetic material made of, for example, Ni—Fe group alloy is formed in such a manner that the soft magnetic material stretches to the return yoke toward the main magnetic pole side. By absorbing unnecessary write magnetic fields generated by the main magnetic pole toward the recording medium, the trailing shield type write magnetic element plays a role of making a write magnetic field gradient steeper.

The cusp coil type write magnetic element shown in IEEE Trans. Magn., vol. 36, no. 5, pp. 2520-2523, 2000, for example, is characterized in that a thin film coil and a return yoke are disposed both on the trailing side and leading side with respect to the main magnetic pole in such a way that the main magnetic pole is sandwiched. By adopting such a head structure, the main magnetic pole can efficiently be magnetized and write magnetic field intensity of the main magnetic pole can be increased.

Compared with the longitudinal magnetic recording system for both the recording medium and magnetic head, as described above, the perpendicular magnetic recording system has an advantage of higher recording densities of magnetic disk apparatus. However, the write head element part of a magnetic head of the perpendicular magnetic recording has a geometric problem in the plane shape of a tip of the main magnetic pole viewed from an air bearing surface side of the magnetic head and the problem will be described below.

FIG. 1 shows a general internal outline structure of an HDD, which is a type of magnetic disk apparatus. FIG. 2 is a diagram showing how a skew angle by a rotary actuator system is assigned. The HDD generally uses a rotary actuator 21 shown in FIG. 2 as a way of causing the magnetic head to move to a desired recorded track position on a recording medium. Thus, about 15° on both the positive side and negative side will usually be assigned as a skew angle 24 of a magnetic head 23 mounted on a suspension 22 together with a slider. The skew angle is defined as a positive side when an air stream generated between the recording medium and magnetic head enters an outer circumferential leading edge of the magnetic head and gets out of an innermost circumferential trailing edge. That is, when the magnetic head is positioned at a recorded track 25 on the inner circumferential side of the recording medium, the skew angle is assigned to the positive side. When the magnetic head is positioned at a recorded track 26 on the outer circumferential side of the recording medium, the skew angle is assigned to the negative side.

FIG. 3 is a perspective view of a tip portion of a main magnetic pole of a conventional write head element part. The plane shape of the main magnetic pole is rectangular. FIG. 4 shows how the main magnetic pole in FIG. 3 follows a recorded track on a recording medium. In FIG. 4, a plane shape 32 of the tip of a main magnetic pole 31 of the write head element part is rectangular with a long side in the longitudinal direction of the slider. If here a skew angle is assigned, the main magnetic pole 31 will be at some angle with a traveling direction 34 of the recorded track 25 on the inner circumferential side and the recorded track 26 on the outer circumferential side. Accordingly, a portion of the plane of the main magnetic pole tip geometrically protrudes from the recorded track and therefore, a problem arises that an area, that is, a side erase occurrence area 33 in which recorded signals and servo signals on adjacent tracks are deleted occurs.

To address this problem, a method by which adjacent tracks are geometrically made less susceptible when a skew angle is assigned by changing the plane shape of the tip of the main magnetic pole to a trapezoidal double taper shape or single taper shape using (FIB Focused Ion Beam) processing or plating has been proposed (See, for example, Japanese Patent Application Laid-Open No. 2004-94997).

However, since write magnetic field intensity is generally proportional to a plane area of the tip of the main magnetic pole viewed from the air bearing surface side, a problem arises that processing of the tip to a taper shape makes the area smaller and thus reduces write magnetic field intensity. In this case, the recording layer of the recording medium cannot be sufficiently magnetized, creating a new problem of causing degradation of signal quality.

FIG. 5 is a perspective view of the tip portion of a main magnetic pole having a conventional single taper shape. FIG. 6 is a diagram showing how the main magnetic pole in FIG. 5 follows a recorded track on the recording medium. If the single taper shape is adopted for a plane shape 41 of the tip of the main magnetic pole to have write magnetic field intensity maintained, as shown in FIG. 6, the problem of side erasing can be controlled only for one polarity of the positive side or negative side of the skew angle. FIG. 7 is a perspective view of the tip portion of a main magnetic pole having a double taper shape. FIG. 8 is a diagram showing how the main magnetic pole in FIG. 7 follows a recorded track on the recording medium. If the double taper shape is adopted for a plane shape 51, as shown in FIG. 8, the problem of side erasing can be avoided for the skew angle of both the positive side and negative side, but the plane area of the tip of the main magnetic pole viewed from the air bearing surface side becomes too small. Thus, a problem of extremely reduced write magnetic field intensity arises.

As has been described above, controlling side erasing when the skew angle of the magnetic head is assigned and ensuring write magnetic field intensity are in a trade-off relationship and it is difficult to realize both at the same time. This problem becomes more serious as the track density increases, that is, the magnetic disk apparatus has higher-density recording.

It is an object of the present invention to realize a magnetic head structure which can avoid the problem of side erasing regardless of whether the skew angle is assigned to the positive side or negative side while ensuring write magnetic field intensity.

### SUMMARY

In accordance with an aspect of an embodiment, a magnetic head that includes at least two main magnetic poles having a single taper shape as a plane shape of a tip thereof opposite to a recording medium and axially symmetrically disposed with respect to a longitudinal direction of a slider, a return yoke for returning a write magnetic field generated by the main magnetic poles, and thin-film coils assigned to each of the main magnetic poles.

### BRIEF DESCRIPTION OF THE DRAWINGS

FIG. 1 is a general internal outline structure of an HDD, which is one of magnetic disk apparatuses;

FIG. 2 is a diagram showing how a skew angle by a rotary actuator system is assigned;

FIG. 3 is a perspective view of a tip portion of a main magnetic pole of a conventional write head element part;

FIG. 4 shows how the main magnetic pole in FIG. 3 follows a recorded track on a recording medium;

FIG. 5 is a perspective view of the tip portion of a main magnetic pole having a conventional single taper shape;

FIG. 6 is a diagram showing how the main magnetic pole in FIG. 5 follows a recorded track on the recording medium;

FIG. 7 is a perspective view of the tip portion of a main magnetic pole having a conventional double taper shape;

FIG. 8 is a diagram showing how the main magnetic pole in FIG. 7 follows a recorded track on the recording medium;

FIG. 9 is a sectional view of a magnetic head in a first embodiment of the present invention;

FIG. 10 is a top view from an air bearing surface side of the magnetic head in the first embodiment;

FIG. 11 is a perspective view clarifying physical relationships among a main magnetic pole brace layer, a joint part, thin-film coils, a first main magnetic pole and a second main magnetic pole, and an inter-main magnetic pole magnetic shield of the magnetic head in the first embodiment;

FIG. 12 is a diagram showing how a main magnetic pole having the shape of the main magnetic pole in FIG. 11 follows a recorded track on the recording medium;

FIG. 13 is a sectional view of a magnetic head having a cusp coil type write head element part that can be applied to the magnetic head in the first embodiment;

FIG. 14 is a block diagram of a magnetic head switching control circuit, which is to be a second embodiment of the present invention, for controlling the magnetic head in the first embodiment; and

FIG. 15 is a diagram from which the magnetic head switching control circuit in the second embodiment selects a write driver to be used based on head address information and cylinder address information.

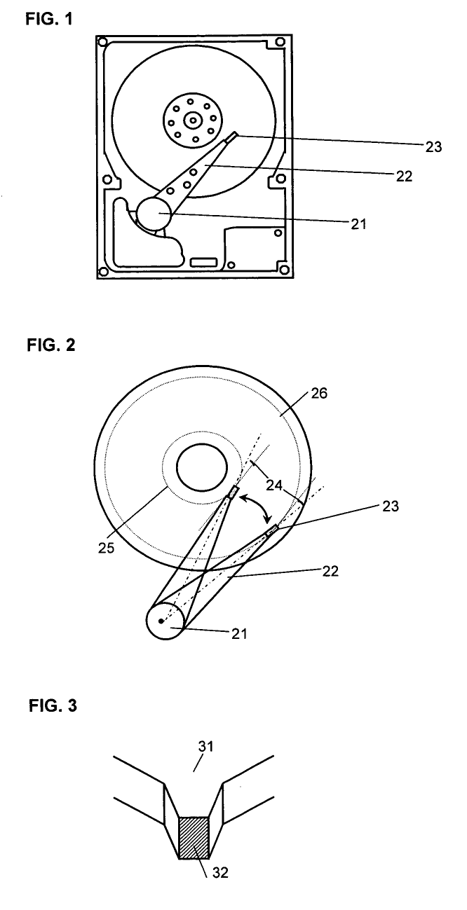

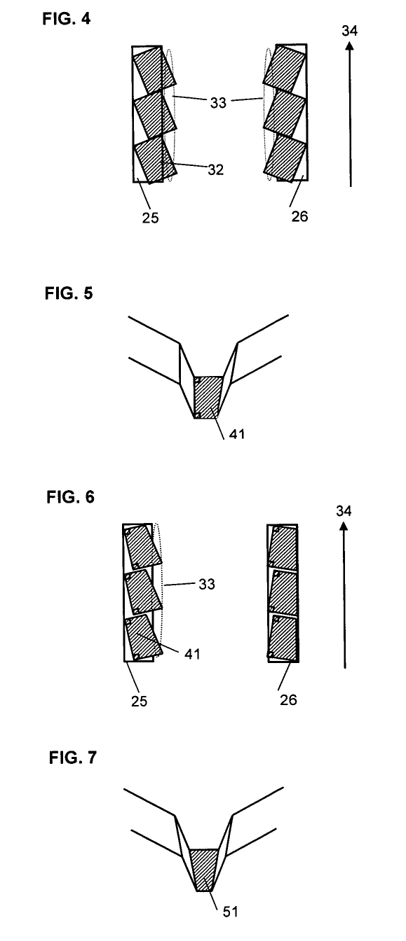

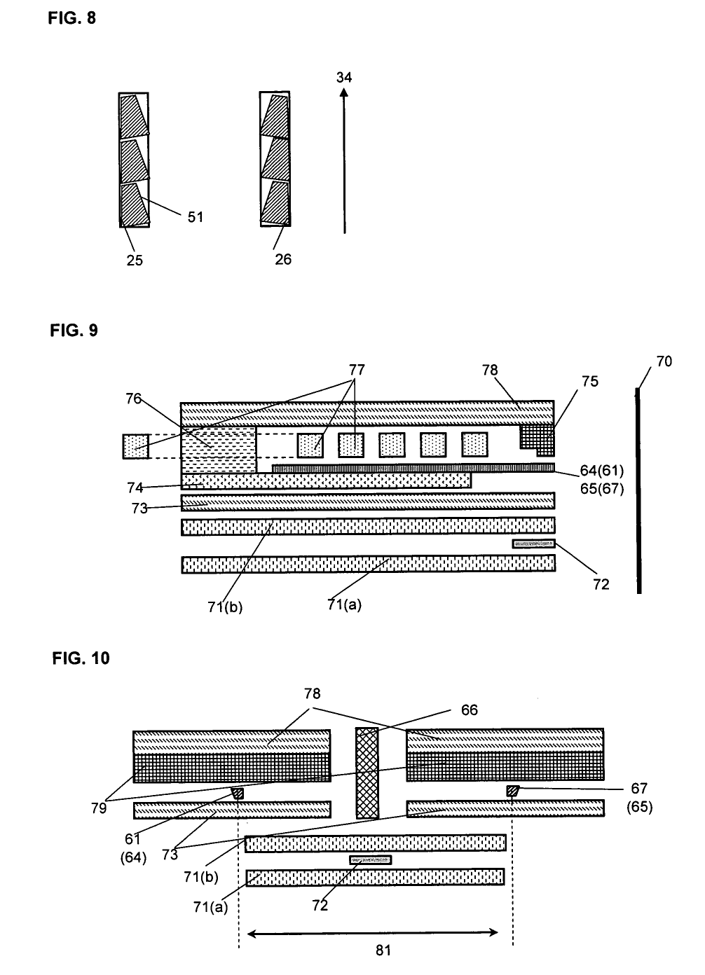

### DETAILED DESCRIPTION OF THE EMBODIMENTS

Embodiments of the present invention will be described below with reference to FIG. 9 or FIG. 15. The general sputtering process, plating process or the like is used as the formation process of each layer described below. Moreover, each layer can be processed to a desired shape using a patterning process using a resist film and lithography or the like. Thus, details of the formation process of each layer are omitted.

FIG. 9 is a sectional view of a magnetic head in a first embodiment of the present invention. Though not shown in FIG. 9, the sputtering process is used to form an alumina layer made of Al₂O₃ with a thickness of about 2 μm as an insulating layer on an alumina/titanium carbide layer made of Al₂O₃—Ti—C with the thickness of about 2 mm. Next, a lower magnetic shield 71(a) made of soft magnetic material such as Ni—Fe is formed on the insulating layer using the plating process. Next, though not shown, the sputtering process is used to form an alumina layer to be a first read gap on the lower magnetic shield 71(a) side with the thickness of about 0.6 μm. Next, a read element 72 of GMR or TuMR with a general structure is formed so that the read element 72 is disposed near a recording medium 70. Also, though not shown, a pair of electrode layers electrically connected to the read element 72 is formed. Next, though not shown, the sputtering process is used to form an alumina layer to be a second read gap on an upper magnetic shield 71(b) side with the thickness of about 0.6 μm. Next, like the lower magnetic shield 71(a), the upper magnetic shield 71(b) made of soft magnetic material is formed.

FIG. 10 is a top view of the magnetic head in the first embodiment viewed from the air bearing surface side. Here, the read element 72 may be mounted at any position because the position of the magnetic head with respect to the recorded track can be determined by correcting an amount of offset of the read head element part and write head element part when reading a recorded signal. Here, the read element 72 was mounted in a center position of the upper and lower magnetic shields 71(a) and 71(b). A read head element part has been prepared by the above steps with the read element 72 of GMR or TuMR sandwiched by the upper and lower magnetic shields 71(a) and 71(b) via an insulating layer.

A method of forming a write head element part will be described below. First, an alumina layer (not shown) is formed with the thickness of 0.3 μm on the upper magnetic shield 71(b) in FIG. 9. Next, a magnetic shield 73 of the write head element made of soft magnetic material such as Hi-Fe is formed using the plating process. Next, a main magnetic pole brace layer 74, a joint part 76, thin-film coils 77, and a return yoke 78 that play a role of supporting first and second main magnetic poles 64 and 65 are formed using the plating process. Here, a Ni—Fe, Co—Fe, or Co—Fe—B group alloy can be selected as a material of the main magnetic pole. Though not shown, a blank portion among the main magnetic pole, joint part 76, thin-film coils 77, and return yoke 78 is filled with an alumina layer using the sputtering process or plating process. Meanwhile, in the embodiments of the present invention, a soft magnetic material layer 75 made of Ni—Fe or the like is formed to make a trailing shield type head in order to make the magnetic field gradient steep. Here, since the present invention has two main magnetic poles, each layer of the write head element part is formed symmetrically with respect to an inter-main magnetic pole magnetic shield 66 made of soft magnetic material such as Ni—Fe in FIG. 10. Meanwhile, the sputtering process or plating process is used to have a space between the first main magnetic pole 64 and second main magnetic pole 65 filled with an alumina layer.

In FIG. 10, the distance between centers of two main magnetic pole planes 61 and 67 was set to 100 nm. If the distance is longer than this, the two main magnetic poles will hardly interact magnetically even if the inter-main magnetic pole magnetic shield 66 is not formed. Thus, no problem will be caused if the inter-main magnetic pole magnetic shield 66 is not formed. However, the read element 72 and the main magnetic pole parts being too far apart is not preferred from the standpoint of design of a magnetic disk apparatus because the amount of offset for determining the position of the magnetic head with respect to a recorded track will be too large.

FIG. 11 is a perspective view clarifying physical relationships among the main magnetic pole brace layer 74, joint part 76, thin-film coils 77, first main magnetic pole 64 and second main magnetic pole 65, and inter-main magnetic pole magnetic shield 66 of the magnetic head in the first embodiment. Here, the first main magnetic pole 64 and second main magnetic pole 65 are axially symmetric with respect to a longitudinal direction 95 of the slider. The single taper shape in the plane of the tip of the main magnetic pole is processed into a shape in which the main magnetic pole becomes wider from a leading side 62 to a trailing side 63, which is a traveling direction of the magnetic head relative to the recording medium. Meanwhile, dimensions and the taper angle of the tip of the main magnetic pole should suitably be designed based on the degree of skew angle assigned to the magnetic disk and the track density. Here, an upper side 91 was set to 160 nm, a taper angle 92 to 60°, a height 93 to 190 nm, and a lower side 94 to 130 nm.

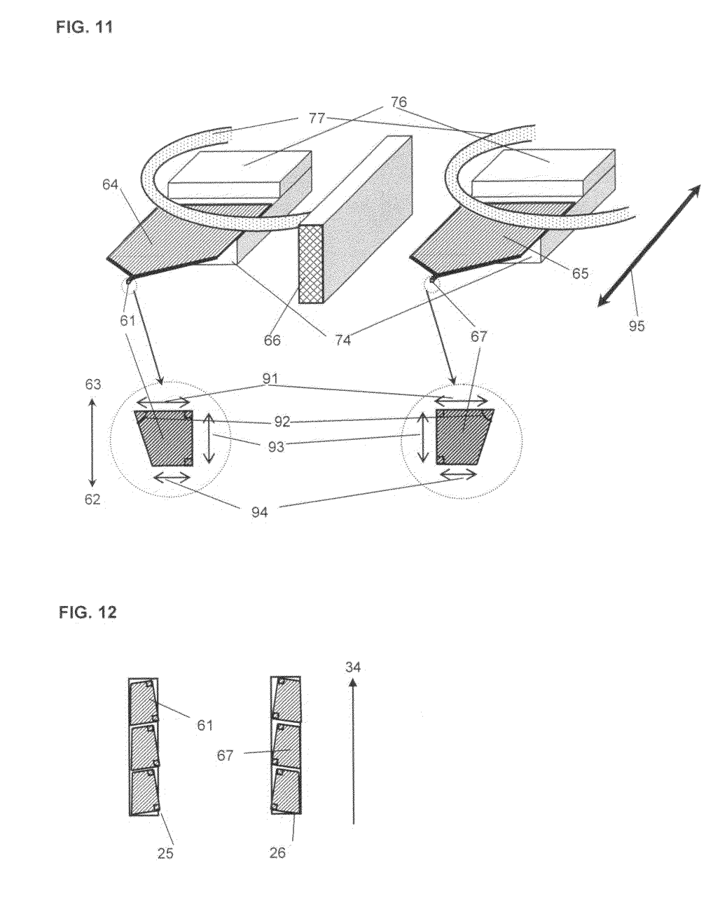

FIG. 12 is a diagram showing how a main magnetic pole of the main magnetic pole in FIG. 11 follows a recorded track on the recording medium. As shown in FIG. 12, in a positive skew angle area on the inner circumferential side of the recording medium, recording is performed on a predetermined recorded track by causing the first main magnetic pole 64 to generate a write magnetic field disposed in such a way that the plane of the tip of the main magnetic pole is like a taper shape toward an inner circumferential direction 68 of the recording medium. In this case, the plane 61 of the first main magnetic pole is within the recorded track 25 on the inner circumferential side. Thus, the side erase occurrence area can be eliminated. In a negative skew angle area on the outer circumferential side of the recording medium, recording is performed by the second main magnetic pole 65 disposed in such a way that the plane of the tip of the main magnetic pole is like a taper shape toward an outer circumferential direction 69 of the recording medium. The plane 67 of the second main magnetic pole is within the recorded track 26 on the outer circumferential side. Thus, the side erase occurrence area can be eliminated. Furthermore, for an area where the skew angle is 0°, recording can be performed using any of the main magnetic poles.

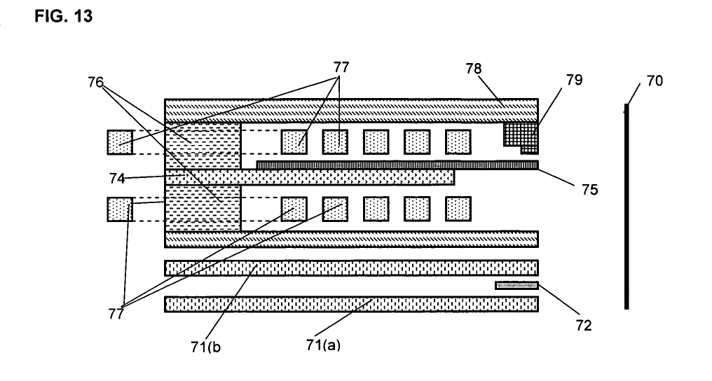

As an application of the embodiments of the present invention, various magnetic poles can be used for different purposes depending on the skew angle by forming a plurality of main magnetic poles with different skew angles in consideration of side erasing when the track density increases due to higher recording densities of the magnetic disk apparatus. Also in this case, the taper angle may be designed in accordance with the degree of assigned skew angle. That is, the taper angle may be increased for a zone to which a large skew angle is assigned. FIG. 13 shows a sectional view of a magnetic head having a cusp coil type write head element part that can be applied to the magnetic head in the first embodiment. In the embodiments of the present invention, as shown in FIG. 11, the application is easy because it is sufficient to form two main magnetic poles symmetrically with respect to a recorded track method.

According to the present embodiment, an occurrence of side erasing can be controlled without lowering write magnetic field intensity by using the first main magnetic pole 64 and second main magnetic pole 65 for different purposes in accordance with the polarity of the skew angle.

Next, when using a magnetic head of the present invention in a magnetic disk apparatus, it is necessary to selectively use two main magnetic poles depending on the polarity of assigned skew angle. A control method thereof will be described below.

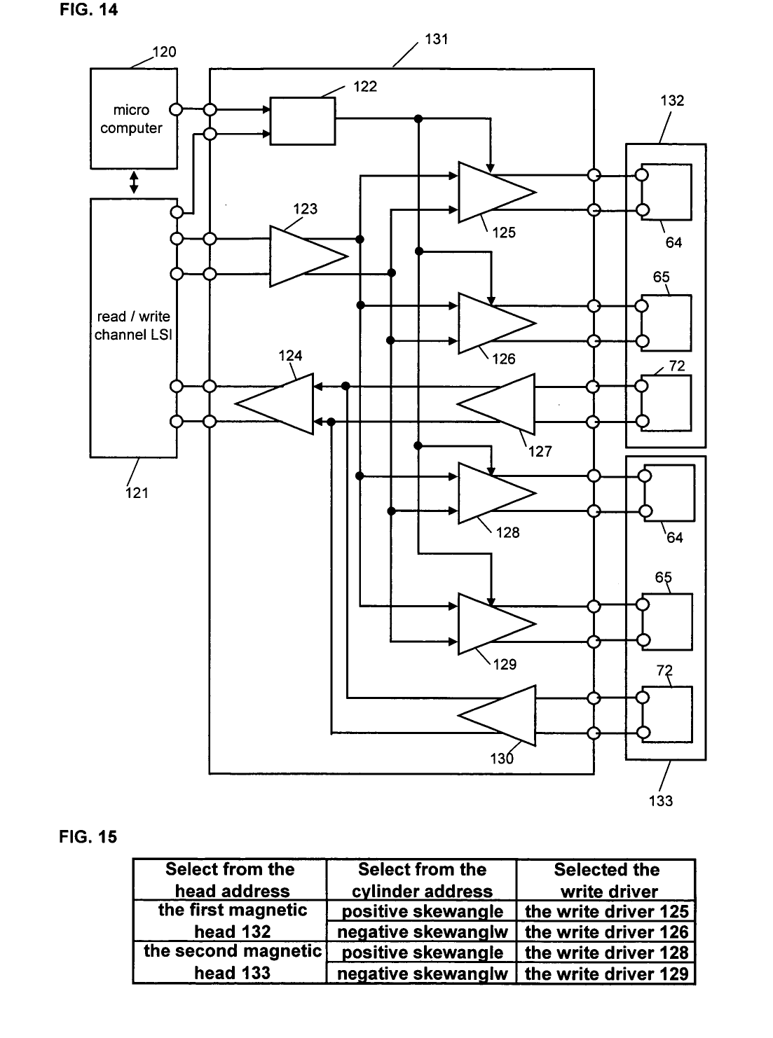

FIG. 14 is a block diagram of a magnetic head switching control circuit, which is to be a second embodiment of the present invention, for controlling the magnetic head in the first embodiment. This block diagram is a block diagram for controlling a plurality of magnetic heads in order to actually use the magnetic heads in a magnetic disk apparatus. Here, a method of using two magnetic heads, a first magnetic head 132 and a second magnetic head 133, will be described. In each of the first magnetic head 132 and second magnetic head 133, the read element 72, first main magnetic pole 64, and second main magnetic pole 65 are mounted. Though not shown, a bias current source applied to the read head element part and a write current source applied to the write head element part are disposed in a head amplifier IC part 131. Here, a normal read method by which the read element 72 of the first magnetic head 132 or second magnetic head 133 amplifies a read signal from a recording medium using read amplifier parts 127 and 130 and sends data to a read/write channel LSI part 121 via a read data buffer part 124 is used.

Though not shown, the read/write channel LSI part 121 has functions to code write data before sending the write data to a write data buffer part 123 disposed in the head amplifier IC part 131 and to decode read data received from the read data buffer part 124. The read/write channel LSI part 121 also has a head address control part for selecting a magnetic head to be used for a recording medium with a plurality of surfaces disposed in a magnetic disk apparatus. Meanwhile, the read/write channel LSI part 121 also has a signal processing circuit part of the PRML (Partial Response Maximum Likelihood). Though not shown, a microcomputer part 120 has a cylinder address control part of recording tracks of a recording medium. The microcomputer part 120 also has control parts of interfaces and LSI parts.

Here, a magnetic head switching control circuit 122 disposed in the head amplifier IC part 131 acquires cylinder address information of recording tracks from the microcomputer part 120. The magnetic head switching control circuit 122 acquires head address information from the read/write channel LSI part 121. The magnetic head switching control circuit 122 selects either of the first magnetic head 132 and second magnetic head 133 to be used based on the head address information. The selected magnetic head has two main magnetic poles. Thus, the magnetic head switching control circuit 122 determines the polarity of the skew angle of the recording track where a record should be made based on the cylinder address information to select write drivers 125 and 128 for the positive skew angle area of the first main magnetic pole 64 or write drivers 126 and 129 for the negative skew angle area of the second main magnetic pole 65 to be used. With this operation, a recording operation to the recording medium is performed.

FIG. 15 shows a diagram from which the magnetic head switching control circuit 122 in the second embodiment selects a write driver to be used based on head address information and cylinder address information. As shown in FIG. 15, a plurality of magnetic heads having two or more main magnetic poles in the present invention can be controlled by entering head address information and cylinder address information in the magnetic head switching control circuit 122.

What is claimed is:

1. A magnetic head; comprising:
at least two main magnetic poles having a single taper shape as a plane shape of a tip thereof opposite to a recording medium and axially symmetrically disposed with respect to a longitudinal direction of a slider;
a return yoke for returning a write magnetic field generated by the main magnetic poles; and
thin-film coils assigned to each of the main magnetic poles.

2. The magnetic head according to claim 1, wherein the single taper shape in a plane of the tip of the main magnetic pole is a shape in which the main magnetic pole becomes wider from a leading edge side to a trailing edge side, which is a traveling direction of the magnetic head relative to the recording medium.

3. The magnetic head according to claim 1, wherein when at least two main magnetic poles are disposed, a magnetic shield made of soft magnetic material is formed between the adjacent main magnetic poles.

4. The magnetic head according to claim 1, comprising a trailing shield type write magnetic element disposed at the tip of the return yoke with a soft magnetic material on a side closer to the tip of the main magnetic pole.

5. The magnetic head according to claim 1, comprising a cusp coil type write magnetic element, wherein a coil is formed by sandwiching the main magnetic pole from above and from below with the thin-film coils having at least two layers.

6. A magnetic disk apparatus; comprising:
a magnetic head having at least two main magnetic poles having a single taper shape as a plane shape of a tip thereof opposite to a recording medium and axially symmetrically disposed with respect to a longitudinal direction of a slider, a return yoke for returning a write magnetic field generated by the main magnetic poles, and thin-film coils assigned to each of the main magnetic poles; and
a recording medium.

7. The magnetic disk apparatus according to claim 6, wherein the single taper shape in a plane of the tip of the main magnetic pole is a shape in which the main magnetic pole becomes wider from a leading edge side to a trailing edge side, which is a traveling direction of the magnetic head relative to the recording medium.

8. The magnetic disk apparatus according to claim 7, wherein a point where a skew angle of the magnetic head becomes 0° on the recording medium is defined as a reference point, and recording is performed on an inner circumferential side from the reference point by a first main magnetic pole disposed in such a way that the plane of the tip of the main magnetic pole has a taper shape toward an inner circumferential direction of the recording medium and recording is performed on an outer circumferential side from the reference point by a second main magnetic pole disposed in such a way that the plane of the tip of the main magnetic pole has a taper shape toward an outer circumferential direction of the recording medium.

9. The magnetic disk apparatus according to claim 6, wherein recording by first and second main magnetic poles is switched by a write current control part and a write data buffer part of a head amplifier in accordance with polarity of a skew angle.

10. A magnetic head switching control circuit, wherein a main magnetic pole to be used is selected from and recording is instructed to two or more main magnetic poles of a magnetic head disposed in accordance with cylinder address of a recording medium and head address of the magnetic head.

11. The magnetic disk apparatus according to claim 6, comprising the magnetic head switching control circuit.
